(19) United States
(12) Patent Application Publication
(10) Pub. No.: US 2003/0069743 A1
(43) Pub. Date: Apr. 10, 2003

(54) System and method for energy and green-house gas inventory management

(76) Inventor: Susann B. Nordrum, Corte Madera, CA (US)

Correspondence Address: Timothy J. Hadlock, Chevron Corporation, P.O. Box 6006, San Ramon, CA, 94583-0806, US

(21) Appl. No.: 10/000,718

(22) Filed: Oct. 30, 2001

Related U.S. Application Data
(60) Provisional application No. 60/323,906, filed on Sep. 21, 2001.

(51) Int. Cl. G06F 17/60

(52) U.S. Cl. 705/1

(57) ABSTRACT

The invention includes a method for energy usage and green-house gas inventory management including: entering input data and input source descriptions for the input from green-house-gas-producing processes at a field site into a computer-readable file; passing the input data to a green-house-gas calculating module; outputting green-house-gas emissions based on the input data; passing the input, input source descriptions, and the output over a network to an output integration program; integrating the output with a plurality of other output from at least one other field sites; mapping the integrated output into a relational database schema; and storing the mapped integrated output in a relational database.

### COPYRIGHT NOTICE AND AUTHORIZATION

This patent document contains material which is subject to copyright protection.

© Copyright 2001 Chevron U.S.A. Inc. All rights reserved.

With respect to this material which is subject to copyright protection, the owner, Chevron U.S.A. Inc., has no objection to the facsimile reproduction by any one of the patent disclosure, as it appears in the Patent and Trademark Office patent files or records of any country, but otherwise reserves all rights whatsoever.

### FIELD OF THE INVENTION

This invention relates to a system and method for energy and green-house gas inventory management, especially as relates to the petroleum industry.

### BACKGROUND OF THE INVENTION

Due to worldwide concerns that certain gases, e.g., carbon dioxide, methane and other so-called “greenhouse gases” (“GHG”), might be contributing to dangerous changes in the global climate, responsible businesses are beginning to develop inventories of their emissions of these gases. Developing the inventory requires gathering raw data, documenting the data source, using formulas to estimate GHG emissions based on the raw data, compiling the estimated emissions to get a company total, and generating reports for various purposes.

Within the industry, some companies have approached this problem in a step-wise manner without integration of all the steps. Data is requested with or without documentation. The data is then transferred by hand or electronically to a spreadsheet to do calculations on the data. The calculated results then have to be transferred to other spreadsheets to generate reports or to understand company total emissions.

Some companies outside the petroleum industry, e.g., mining, have attempted to develop systematic processes for managing greenhouse gas emission data. However, no system exists, especially one for an integrated petroleum company. A GHG emissions estimating system and data model is needed, especially one for the petroleum industry so that the documentation, worksheet and database can be electronically linked and include all aspects of the petroleum industry, including refining, marketing, production, and pipeline operations.

In such a system data should be gathered in a form that supports documentation. The original, documented data should be electronically copied to a spreadsheet that performs the calculations. Calculated emission estimates are then preferably electronically transferred to a database, which is used to generate company totals and reports. The database also extracts raw data and supporting information so that if calculational formulas change, the stored data can be electronically transferred to new spreadsheets to use the new emission estimating formulas.

An integrated data model would be unique, and the ability to review and change calculations is also different from existing systems. Linkage of the Excel spreadsheet, e.g., to the Access data base, e.g., for the purpose of estimating GHG emissions is not present in existing systems.

Such a system should be amenable to being implemented on a variety of platforms and network configurations, e.g., client-server, Transmission Control Protocol/Internet Protocol, and others. The calculation steps may be performed at various phases of the process, i.e., earlier or later steps. The calculation logic may reside at one or more of the various stages, subsystems, e.g., in Excel or other spreadsheet program at an early stage, or in Access, Oracle or other database management system, or other subsystem in a later stage. Access to the raw data and calculated data and various reports may be made through various means, e.g., over a network, to various authorized persons, with different access levels for different persons.

Parts of the system are optionally electronically connected with one or more government agencies, consultants or other parties for transmission of, or access to, data or reports. Connections with government agencies are optionally used to meet regulatory filing requirements. Connections within or between other systems in an enterprise are optionally with one or more ERP systems or other back-office systems such as are commercially available, e.g., from SAP Aktiengesellschaft or J. D. Edwards & Company.

The system and method of the present invention provides such a solution.

### SUMMARY OF THE INVENTION

The invention includes a method for green-house gas inventory management including: entering input data and input source descriptions for the input from green-house-gas-producing processes at a field site into a computer-readable file; passing the input data to a green-house-gas calculating module; outputting green-house-gas emissions based on the input data; passing the input, input source descriptions, and the output over a network to an output integration program; integrating the output with a plurality of other output from at least one other field site; mapping the integrated output into a relational database schema; and storing the mapped integrated output in a relational database.

Another aspect of the invention is a data processing apparatus for maintaining an inventory of green-house gas emissions, including: a Central Processing Unit (CPU); and a memory operatively connected to the CPU, the memory containing a program adapted to be executed by the CPU and the CPU and memory cooperatively adapted to: displaying a form for inputting data and input source descriptions for the input from green-house-gas-producing processes at a field site into a computer-readable file; passing the input data to a green-house-gas calculating module; calculating green-house-gas emissions based on the input data; passing the input, input source descriptions, and the output over a network to an output integration program; integrating the output with a plurality of other output from a plurality of other field sites; mapping the integrated output into a relational database schema; and storing the mapped integrated output in a relational database.

Another aspect of the invention is a computer program embodied on at least one computer-readable medium, the computer program for maintaining an inventory of green-house gas emissions, including: a code segment configured and adapted for displaying a form for inputting data and input source descriptions for the input from green-house-gas-producing processes at a field site into a computer-readable file; a code segment configured and adapted for passing the input data to a green-house-gas calculating module; a code segment configured and adapted for calculating green-house-gas emissions based on the input data; a code segment configured and adapted for passing the input, input source descriptions, and the output over a network to an output integration program; a code segment configured and adapted for integrating the output with a plurality of other output from a plurality of other field sites; a code segment configured and adapted for mapping the integrated output into a relational database schema; and a code segment configured and adapted for storing the mapped integrated output in a relational database.

These and other features and advantages of the present invention will be made more apparent through a consideration of the following detailed description of a preferred embodiment of the invention. In the course of this description, frequent reference will be made to the attached drawings.

### BRIEF DESCRIPTION OF THE DRAWINGS

FIGS. 1 and 2 are schematic block system diagrams of two embodiments of the invention.

FIG. 3 is a schematic block conceptual data model, entity-relationship diagram depicting, in one embodiment of the invention, the entities participating in the invention and their relationships.

FIG. 4 is an example in one embodiment of a logical data model, i.e., relations for use in the database aspect of the invention

FIG. 5A is a schematic process model, level 0 flow chart diagram of one embodiment of the invention.

FIG. 5B is a schematic process model, level 1 data flow diagram (a first decomposition of the system diagram in FIG. 5A) and shows logical data flow between major processes of one embodiment of the invention.

FIG. 6 is a schematic process model, level 1 data flow diagram showing logical data flow between major processes of one embodiment of the GHG Data Extraction Module of the invention.

FIG. 7 depicts in one embodiment of the invention, exemplary simplified data domain descriptions for the data input aspect of the invention.

FIG. 8 is a schematic process model, data flow diagram and shows logical data flow between major processes of one embodiment of the configuration aspect of the invention.

FIGS. 9, 10 and 11 depict in particular embodiments of the invention, an exemplary user interface depicting configuration forms for the data input aspect of the invention.

FIG. 12 depicts in one embodiment of the invention, an exemplary user interface depicting data input forms.

FIGS. 13A and 13B depict in one embodiment of the invention, exemplary SQL queries to a relational database storing an integrated GHG inventory.

FIGS. 14 and 15 depict in one embodiment of the invention, exemplary reports from a relational database used in the invention in storing an integrated GHG inventory.

### DETAILED DESCRIPTION OF PREFERRED EMBODIMENTS

A. Introduction

The following discussion and figures include a general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to the drawings, in which like numerals represent like elements throughout the several figures, aspects of the present invention and a suitable operating environment will be described.

B. System

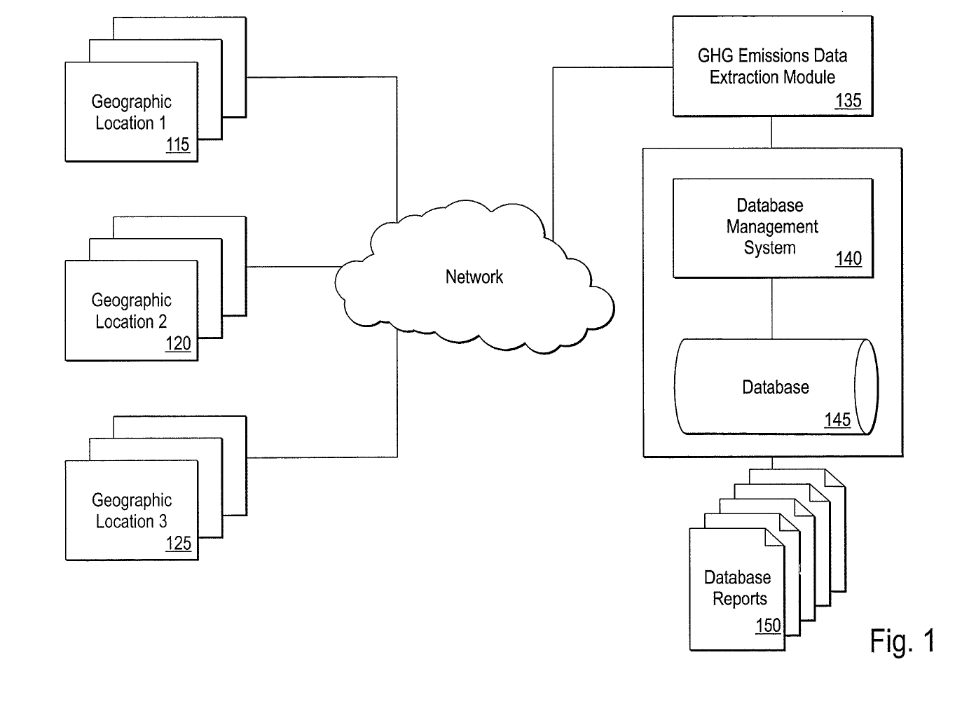

FIG. 1 is a schematic block system diagram of one embodiment of the invention. Each entity involved in the method, in one embodiment, is depicted. GHG Emissions Data Extraction Module 135 is connected with Database Management System 140, which is connected to Database 145. Multiple geographic locations having GHG emitting processes, e.g., Geographic Locations 1, 2 and 3, having reference numbers 115,120 and 125, respectively, are connected over network 130 to GHG Emissions Data Extraction Module 135.

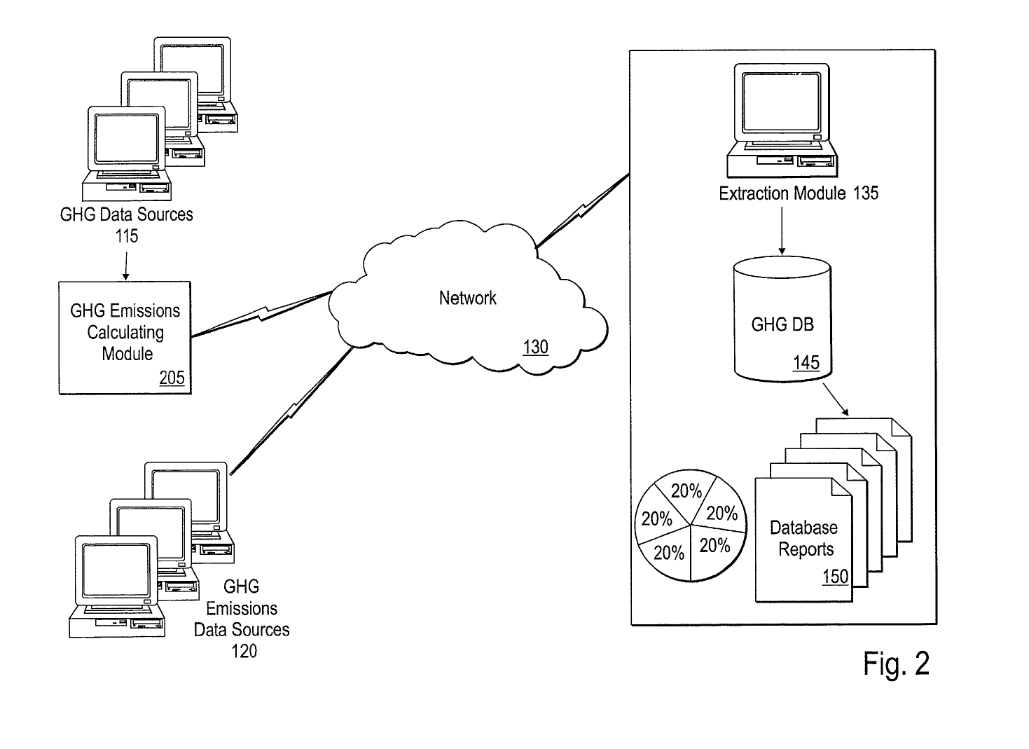

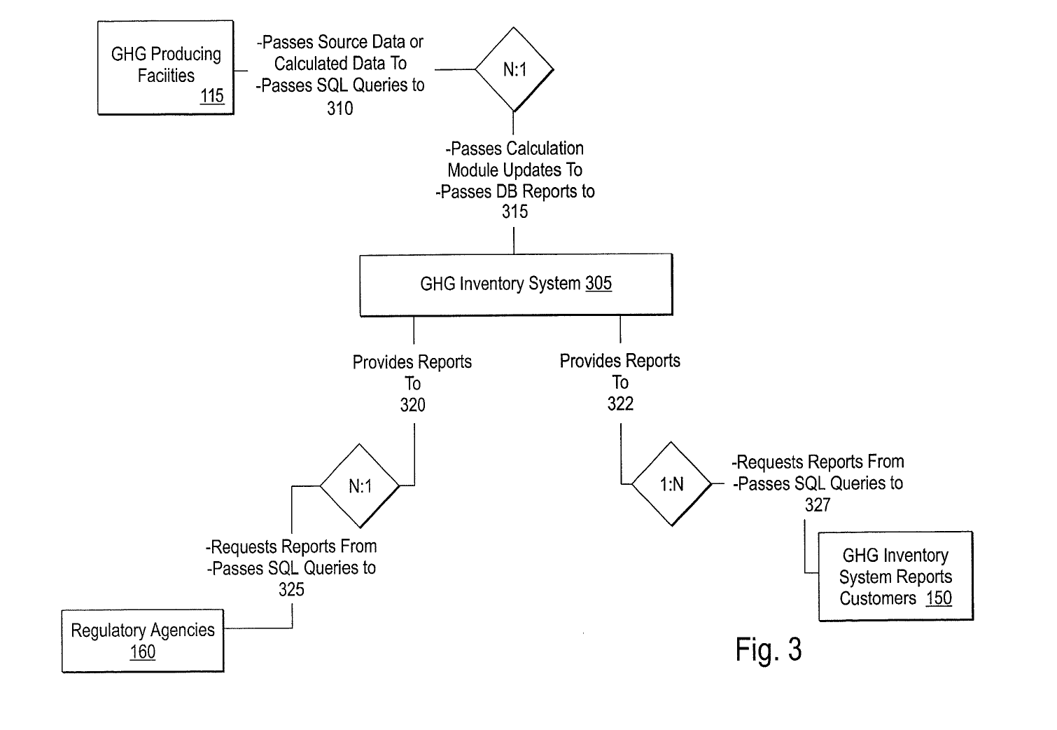

FIG. 2 is an alternate embodiment of a block system diagram. It is substantially the same as FIG. 1, and the primary differences are discussed below. Geographic Locations 1, 2, and 3 are replaced with two categories of GHG Data Sources. One, GHG Data Source 115, is connected to GHG Emissions Calculating Module 205, which in turn is connected to network 130. The other, GHG Calculated Emissions Data Sources 120 is directly connected with network 130, without passing through the GHG Emissions Calculating Module 205. Additional entities are optionally connected over network 130 to GHG DB 145. These optionally include regulatory agencies (shown as reference number 160 in FIG. 3 discussed below).

The relationships between these and additional optional entities are provided in FIG. 3. Network 130 is optionally the Internet or other public or private networks or combinations thereof. The communication of all entities through a common Network 130 is illustrative only, and the invention includes embodiments where some entities communicate through one network, other entities through a different network, and various permutations thereof. That is, the GHG Inventory System 305, as well as any general-purpose computers utilized by GHG Producing Facilities 105 and other entities (collectively, the “nodes”) preferably transmit digitally encoded data and other information between one another.

The communication links between the nodes preferably comprise a cable, fiber or wireless link on which electronic signals can propagate. For example, each node may be connected via an Internet connection using a public switched telephone network (PSTN), such as those provided by a local or regional telephone operating company. Alternatively, each node may be connected by dedicated data lines, cellular, Personal Communication Systems (“PCS”), microwave, or satellite networks.

FIG. 3 is a schematic diagram depicting a conceptual data model/entity-relationship diagram. It shows the key entities of one embodiment of the invention and their interrelationships and key messages transferring between the entities in the practice of the method and system of the invention. The diagram is described in the context of an example for one embodiment of a method/process according to the invention.

One or more GHG Producing Facilities 115 pass source data and/or calculated data 310 to GHG Inventory System 305. GHG Inventory System 305 extracts the passed data and organizes and stores it in a database. Regulator Agencies 160 and/or GHG Inventory System Reports Customers 150, request reports, 325 and 327, respectively, from GHG Inventory System 305 and GHG Inventory System 305 passes back Database Reports 320 and 327, respectively. The GHG Producing Facilities 115 also optionally request reports from and receive reports from GHG Inventory System 305.

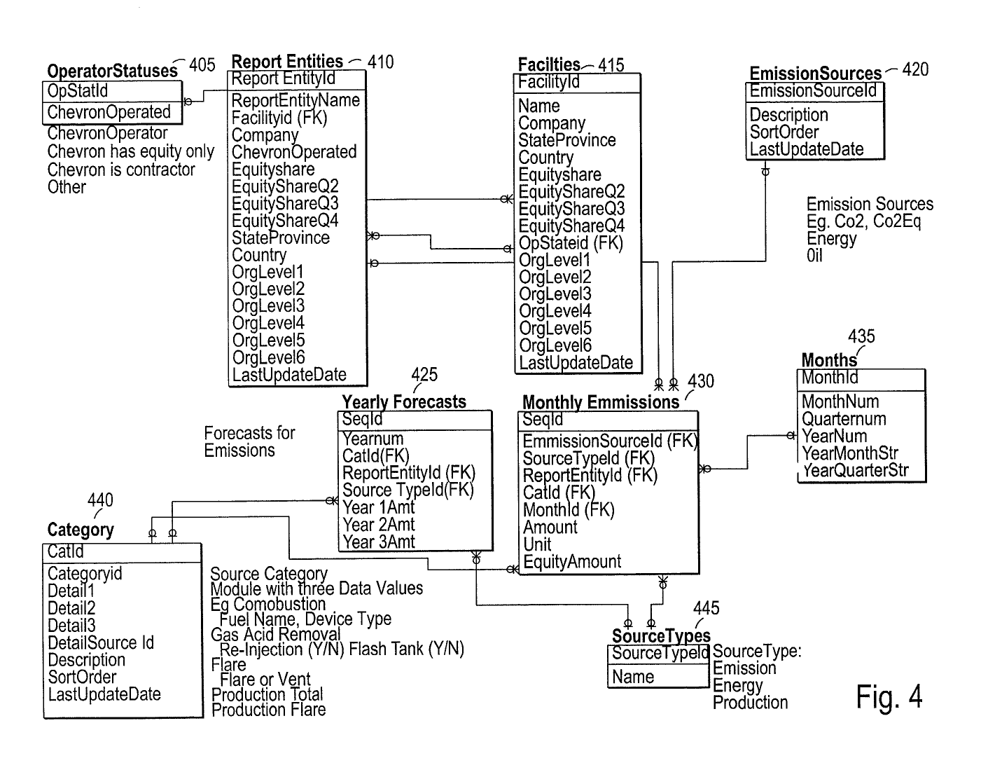

FIG. 4 is an example in one embodiment of a logical data model, i.e., relations for use in the database aspect of the invention. By way of background, databases require a consistent structure, termed a schema, to organize and manage the information. In a relational database, the schema is a collection of tables. For each table, there is generally one schema to which it belongs. In an implementation of a relational database, a relation corresponds to a table having rows, where each row corresponds to a record (or tuple), and columns, where each column corresponds to a field (or attribute). From a practical standpoint, rows represent records of related data and columns identify individual data elements.

Report Entities Table 410 contains information such as Company name, Country, and Equity Share. Its key is Report Entityld and it is related to Facilities Table 415 by foreign key Facilityld. Facilities Table 415 contains attributes such as Name, Company, and Country of the Facility. Facility Table 415 is related to Operator Statuses Table 405 by foreign key OpStatld. Operator Statuses Table 405 stores the operator of a Facility.

Monthly Emissions Table 430 contains attributes storing an Emissions Source, Source type, and emissions amounts. Its key is Seqld and it is related to Emission Sources Table 420 by foreign key Emission Sourceld, to SourceTypes Table 445 by foreign key Source Typeld, to Months Table 435 by foreign key Monthid, to Report Entities Table 410 by foreign key Report Entityld, and to Category Table 440 by foreign key Catld. Category Table 440 stores attributes relating to the type of GHG emission. Yearly Forecasts Table 425 stores information on predicted emissions for particular Reporting Entities.

FIG. 4 is only one exemplary logical data model. Modification of the shown tables as well as additional tables, their domains, keys, and links to other tables, and associated queries and reports, and appropriate normalization of each, useful in implementing the databases used in the invention, given the disclosure herein, could be implemented by data base designers of ordinary skill in the art.

C. Method

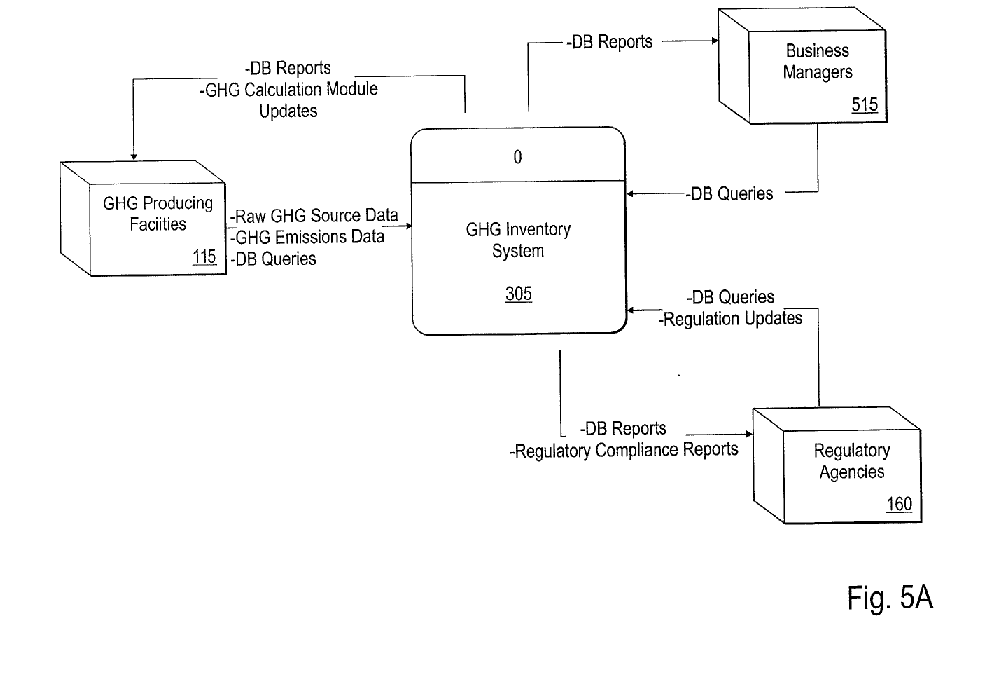

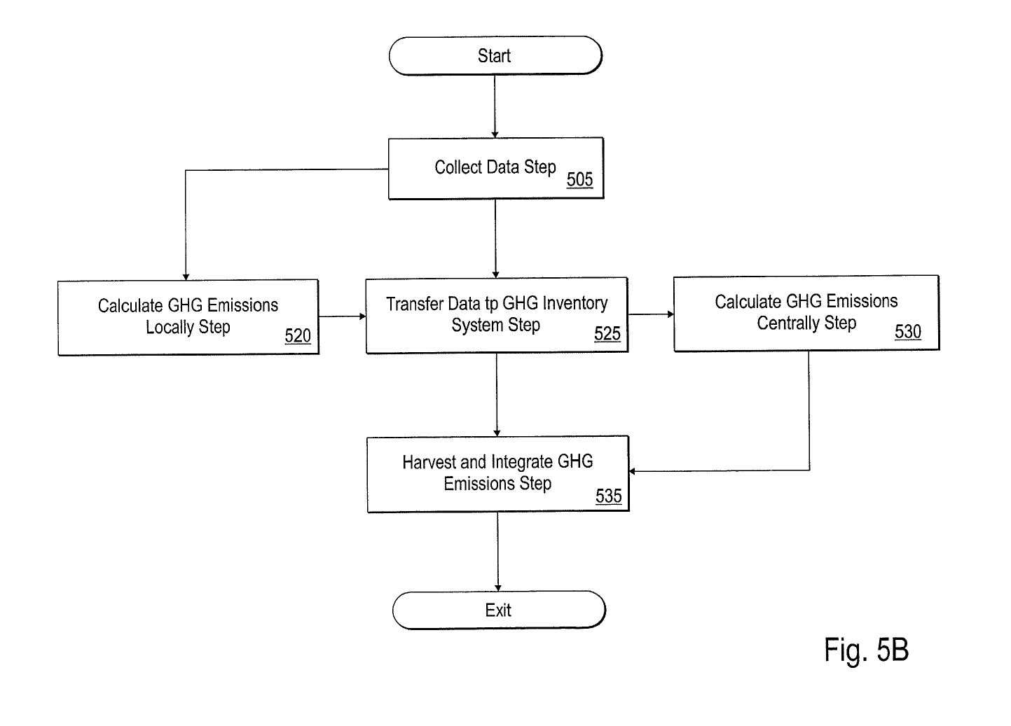

The method/process aspect of the invention is illustrated and described in FIGS. 5A, 5B and 6 as a series of process steps. As would be clear to one skilled in the art, the process steps can be embodied as code for a computer program for operation on a conventional programmed digital computer, such as used by GHG Emitting Facilities 115 and GHG Inventory System 305. (each shown in FIG. 1). The program code can be embodied as a computer program on a computer-readable storage medium or as a computer data signal in a carrier wave transmitted over Network 130 (shown in FIG. 1).

FIG. 5A is a schematic process model, level 0 flow chart diagram of one embodiment of the invention. GHG Inventory System 305 passes to GHG Emitting Facilities 115 updates for the GHG Calculation Module. GHG Emitting Facilities 115 install and use the GHG Calculation Module and any updates for processing GHG source data into GHG emissions data. GHG Emitting Facilities 115 pass GHG source data and/or GHG emissions data to GHG Inventory System 305. GHG Inventory System 305 processes the collected data and stores it a GHG Inventory database. Details of the internal processes to GHG Inventory System 305 are in FIGS. 5B and 6, discussed later.

Once stored in the GHG Inventory Database, it may be optionally queried by, e.g, Business Managers 515, Regulatory Agencies 160, GHG Emitting Facilities 115, and optionally other authorized users. Different users may have different query rights set by the system administrator, e.g., some users may only make queries from a standard report list applicable to their area of responsibility. Other users may make custom queries across a wider scope of operations. Once a query is received, the GHG Inventory System 305 processes it and passes the resulting report to the requesting user.

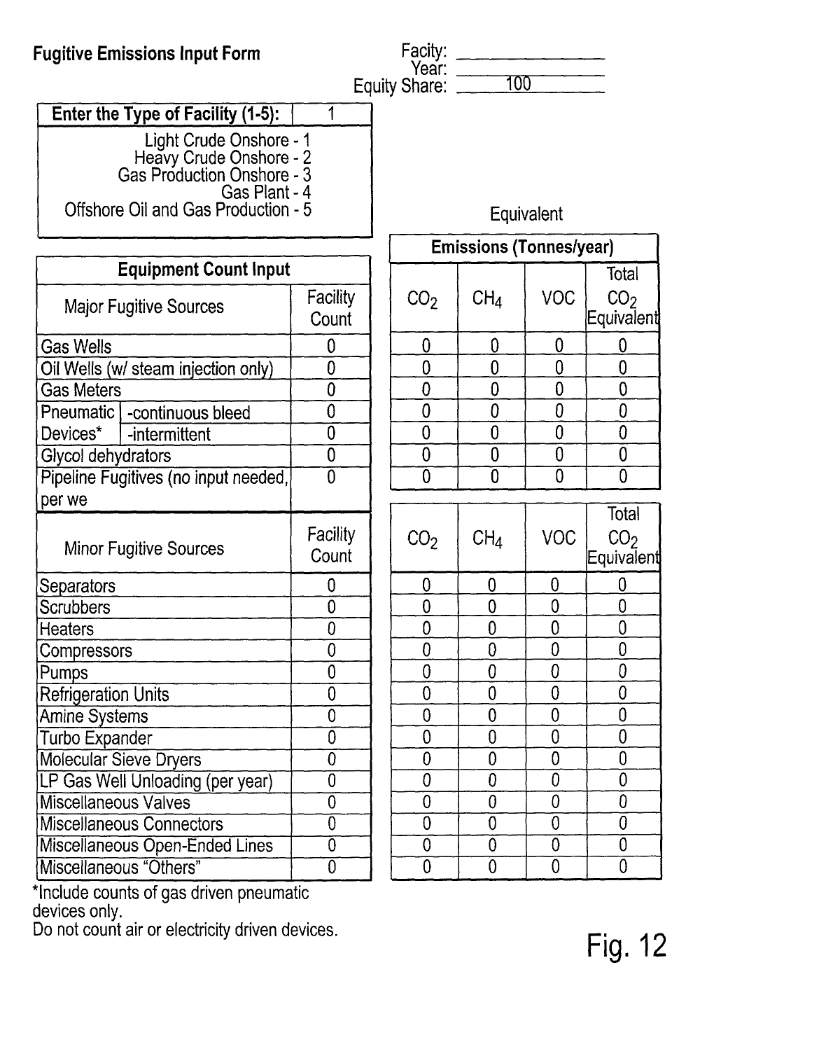

FIG. 5B depicts another view of one embodiment of a process flow diagram for the method of the invention. In Collect Data Step 505 source data is collected. This includes a wide variety of data that is used later for estimating or calculating GHG emissions. Such data includes feed rates, fuel-use rates, coke-burn rates, component counts, hydrogen-plant feed or production rates, temperature, pressure information for flashing calculations, and other relevant data. An exemplary form for collecting data per Step 505 is depicted in FIG. 12 which is discussed later. Data types are either initially in a form, or are later to converted to a form, which is acceptable to the later calculation steps of the invention. Exemplary data types optionally include integers, floats, chars, strings, and optionally references/pointers for any of these data types.

Collect Data Step 505 is typically done at the location of the GHG Emitting Facilities 115. However, the invention optionally includes remote source data collection from a central location via existing or future developed systems such as SCADA (“Supervisory Control and Data Acquisition”) systems and other remote data collection systems. Upon completion of Collect Data Step 505, the data is optionally processed locally at Calculate GHG Emissions Locally Step 520. This step includes both processing on a local client or server processor or regionally. The local calculation Step 520 produces a report or data structure for transfer in Transfer Data to GHG Inventory System Step 525 to Harvest and Integrate GHG Emissions Step 535. The report or data structure from the local calculation Step 520 is in a form readable by the GHG Inventory System in Harvest and Integrate GHG Emissions Step 535. Such forms optionally include conventional or future-developed data structures including flat files, arrays, linked lists, trees, and hash tables.

If it is decided not to process the source data locally or regionally, it is then transferred in raw or semi-processed format to the Transfer Data to GHG Inventory System Step 525 for passing to Calculate GHG Emissions Centrally Step 530. The processing is done to produce a report or data structure as in the output from the local calculation Step 520 for passing to Harvest and Integrate GHG Emissions Step 535.

In Harvest and Integrate GHG Emissions Step 535, the GHG Emissions data is read from the received data structure(s), and mapped to database integrating GHG emissions from several GHG emitting facilities, i.e., “GHG inventory Database.” The GHG Inventory Database is of any conventional or future developed database structure, but preferably is a relational database having an integrated database management system such as are commercially available from, e.g, Oracle (“Oracle9i”) or IBM (“DB2”).

Various conventional or future-developed security measures are optionally implemented to control access the GHG Inventory System 305. For example, at one or more stages is the process, a user may be required to log on using a typical personal computer system or workstation system. Such a system would include typical components such as a bus for communicating information, and a processor coupled with the bus for processing information, random access memory, coupled to the bus for storing information and instructions to be executed by the processor. RAM also may be used for storing temporary variables or other intermediate information during execution of instructions by the processor, a read only memory coupled to the bus for storing static information and instructions for the processor, and a data storage device coupled to the bus for storing information and instructions.

The data storage device may include a magnetic disk or optical disk and its corresponding disk drive can be coupled to the computer system. Also the system may be coupled via the bus to a display device, such as a cathode ray tube, for displaying information to a computer user. The computer system further includes a keyboard and a cursor control, such as a mouse. Any other access devices for accessing a network are intended to be included in the invention. Such devices include properly equipped and configured cellular phones and personal digital assistants.

The message passing in or between one or more of the steps occurs over a network as described. While the preferred network is the Internet, other networks may be used, preferably capable of transmitting using Transmission Control Protocol/Internet Protocol and Hyper-Text Transfer Protocol. The communication links between the entities for implementing the network preferably comprises a cable, fiber or wireless link on which electronic signals can propagate. For example, each entity may be connected via an Internet connection using a public switched telephone network such as those provided by a local or regional telephone operating company. Alternatively, each entity may be connected by dedicated data lines, cellular, Personal Communication Systems, microwave, or satellite networks.

FIG. 6 depicts one embodiment of a process flow diagram for the Harvest and Integrate GHG Emissions Step 535 step/module of the invention. Either the calculated data from Step 530 (FIG. 5) or from Calculate GHG Emissions Locally Step 607 is collected in Collect Data Step 605. The data is transferred to the GHG Inventory System is Step 610, validated in Step 615, and summarized in step 620. Then a summary report is created in Step 625.

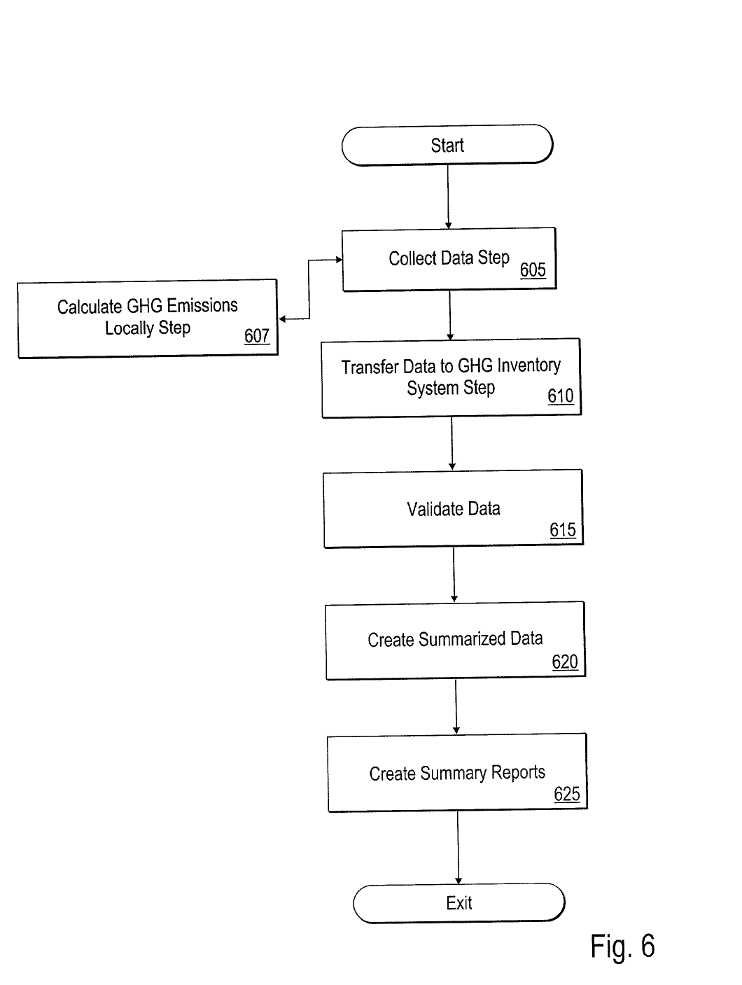

FIG. 7 depicts in one embodiment of the invention, exemplary simplified data domain descriptions for the data input aspect of the invention. Four separate categories of GHG source data are represented which start respectively at row 705, combustion; row 710, venting; row 715, fugitives; and row 720, others. Combustion means GHG produced from combustion of a fuel. Venting is the release of a non-combusted or only partially combusted gas or vapor, e.g., venting of the natural gas that is produced together with oil from a well. Fugitives are GHG emissions from leaking connections in or between equipment or operations involving the equipment, e.g., opening/closing or filling/emptying. The other category covers those GHG sources not in the previous categories. Other categories optionally include coke burn, and hydrogen plants. Many other types too numerous to list are also in this category, but are known in the industry.

For each item listed under a category, columns 730, 735 and 740, optionally give data descriptions for the minimum, improved, and best data types, respectively. For example, for a venting source under row 710, the minimum data requirements are vent rate of the gas/vapor in question per column 730. The units of measurement required are also provided. Improved accuracy of the source data under column 735 includes data on gas type and control device efficiency. The best source data per column 740 would provide the gas composition since knowing the vent rate and the composition permits calculating exact GHG emission levels rather than providing estimates under the minimum and improved data types. A user is free to select any of these data types, but the system does not necessarily guide this selection.

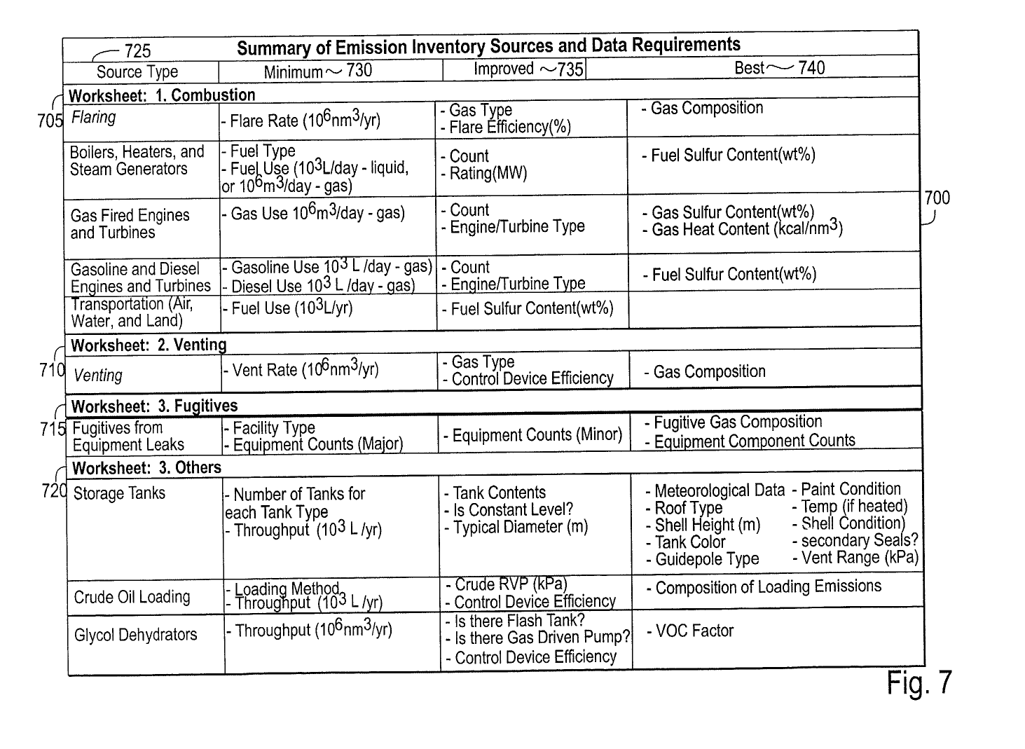

FIG. 8 is a schematic process model, data flow diagram and shows logical data flow between major processes of one embodiment of the configuration aspect of the invention. Configuration typically occurs at the GHG Emitting Facilities where the data collection step is local but may optionally occur at a remote location where the data collection is done remotely. This is done prior to the first use of the system for entering source data. A user begins by defining the GHG Emission Facility in Step 805. This will include describing which categories of GHG emission sources exist at the facility and which items for each category, e.g., from those listed in FIG. 7. Selection is by any conventional or future-developed means, e.g., by command line or by graphical user interface objects such as list boxes, drop down lists, and check boxes. This information is then used to determine which configuration modules are required which are then loaded in Load Configuration Modules 810. “Loading” is understood in the computer science art to include linking selected libraries, functions, or methods and loading them in memory.

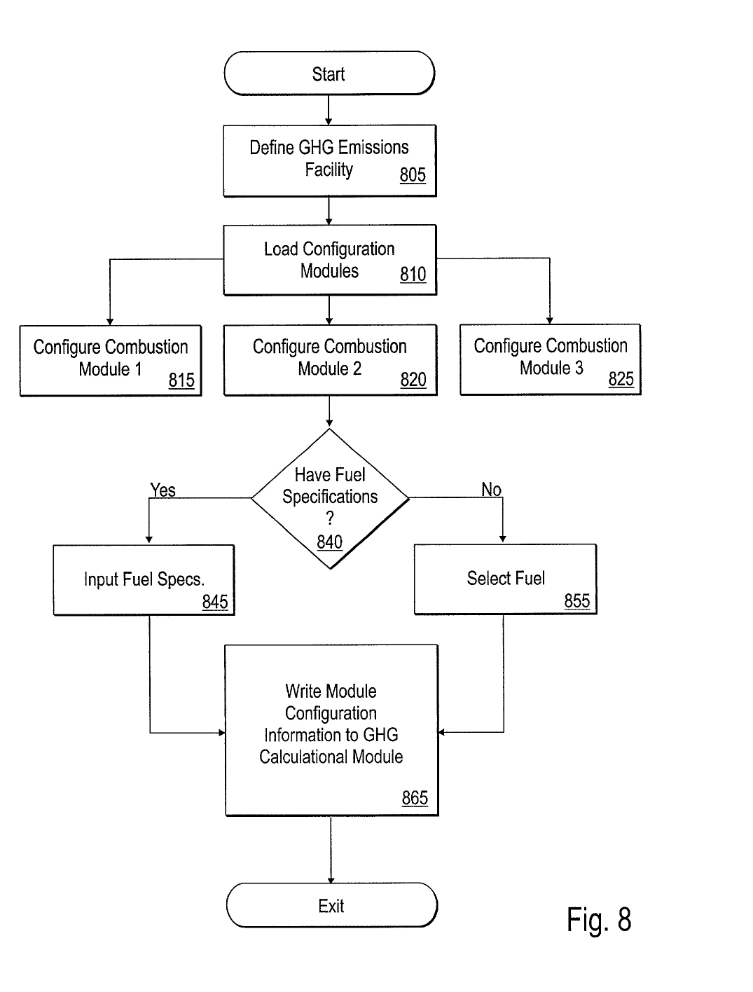

One or more configuration modules are then executed, e.g., Module 1—reference no. 815, Module 2—reference no. 820, or Module n—reference no. 825. The configuration modules optionally provide one or more user interface screens for entering or selecting the appropriate configuration information. A sample series of configuration screens are depicted in FIGS. 9-11, discussed later. As with the selection means described above for define facility Step 805, the user interfaces in the configuration execution steps, e.g., Module 2—Step 820, may include a form with blank text boxes, or a series of forms with text boxes, lists or other GUI objects, or a command line prompt sequence.

An exemplary sequence of steps for executing Combustion Configuration Module 2, reference no. 820 follows. The user is optionally prompted for entering whether the source data is measured or calculated (not shown). If measured, the measurement device is optionally defined (not shown). Whether measured or calculated, or in an embodiment where that is not input, the user is queried as to whether fuel specifications are available in Step 840. If available, a fuel is selected in Step 855, and the corresponding information collected in the above steps is written to the GHG calculation module in Step 860. If the fuel specifications are not available, the user is prompted to input them, then after such input the write Step 860 occurs.

Back at Step 830, if the source data is calculated, the user is queried as to whether fuel specifications are available in Step 840. If available, a fuel is selected in Step 855, and the corresponding information collected in the above steps is written to the GHG calculation module in Step 860. If the fuel specifications are not available, the user is prompted to input them in Step 845, then after such input the write Step 860 occurs. Where fuel composition changes, this information is optionally reentered or updated on a periodic basis, e.g., monthly. Exemplary on-line forms for some of these and/or other steps in configuration are depicted in FIGS. 9-11.

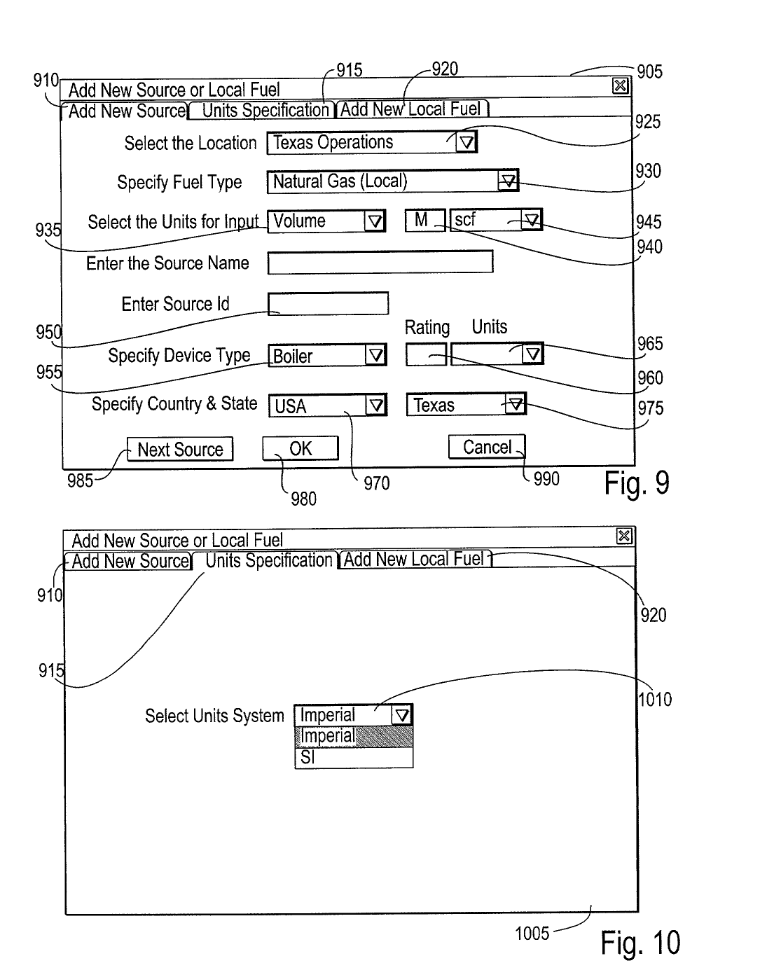

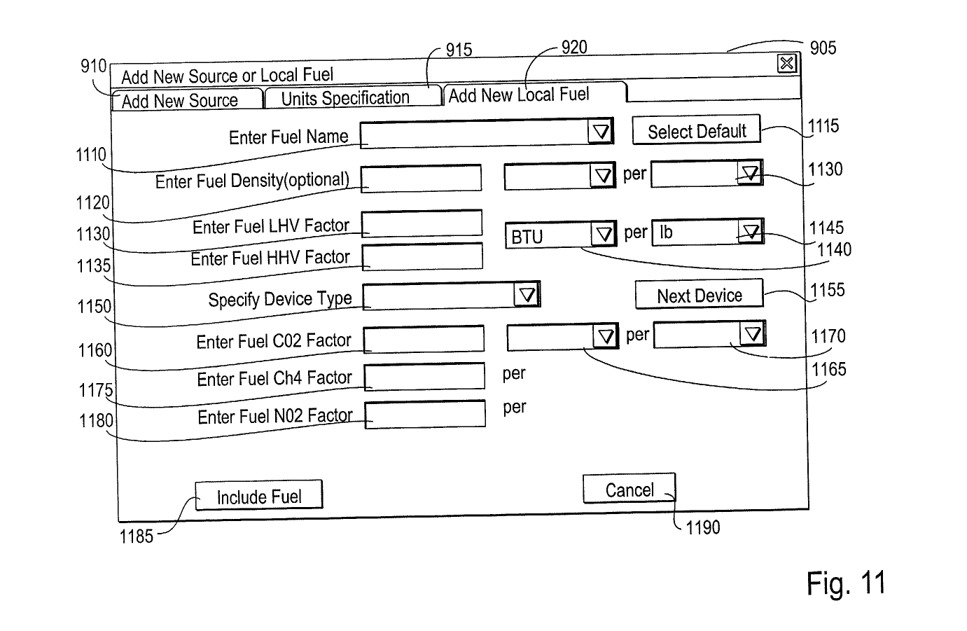

FIGS. 9, 10 and 11 depict in particular embodiments of the invention, an exemplary user interface depicting configuration forms for the data input aspect of the invention. The screen provides three tabs, Add New Source, Units Specification, Add New Local Fuel. For example, in FIG. 9 the Add New Source tab is selected. Under this tab a user selects the facility location from a drop down list, selects the fuel type from a drop-down list, selects units for input, and enters the source name and source id into separate text boxes. Then the user specifies device type, rating, units, country and state. In FIG. 10, the Units Specification tab is selected and the user selects from Imperial or SI units. FIG. 11 depicts the Add New Local Fuel tab where the user enters a fuel name, its density, LHV and HHV factors, device type, and CO₂, CH₄, and N₂O factors.

Modules for each other type of GHG emission optionally has its own configuration steps/modules in the system of the invention. These optionally include modules for flashing, venting, flaring, coke combustion, glycol hydration, transport and storing, and fugitives.

FIG. 12 depicts in one embodiment of the invention, an exemplary user interface depicting data input forms.

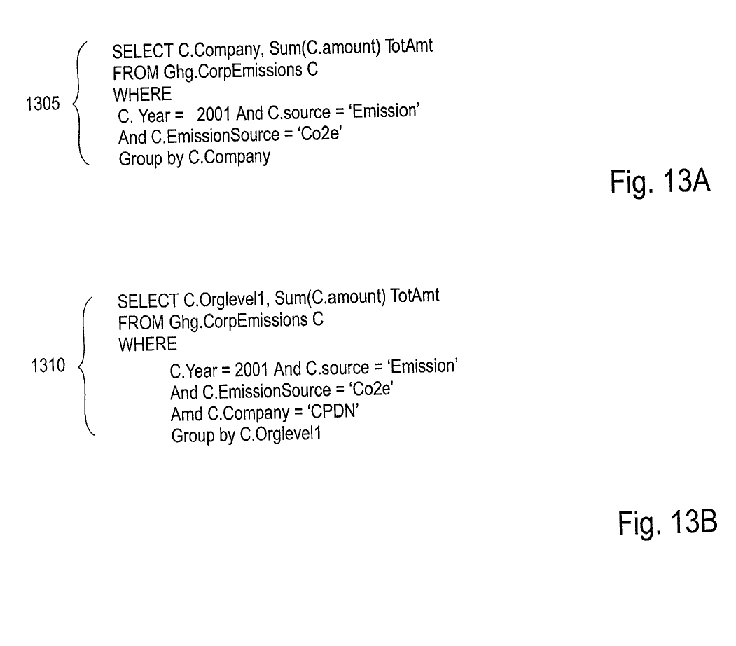

FIGS. 13A and 13B depict in one embodiment of the invention, exemplary SQL queries to a relational database storing an integrated GHG inventory. In FIG. 13A, SQL query 1305 to the system database returns a report by company and total carbon dioxide equivalent emissions during the year 2001 The results are grouped by company name. In FIG. 13B, SQL query 1310 to the system database returns a report of the organization level 1 and total GHG emissions where the emission is carbon dioxide equivalent and for a particular company. The results are group by organizational level 1. This query is appropriate for a company having many GHG emitting facilities organized into various levels.

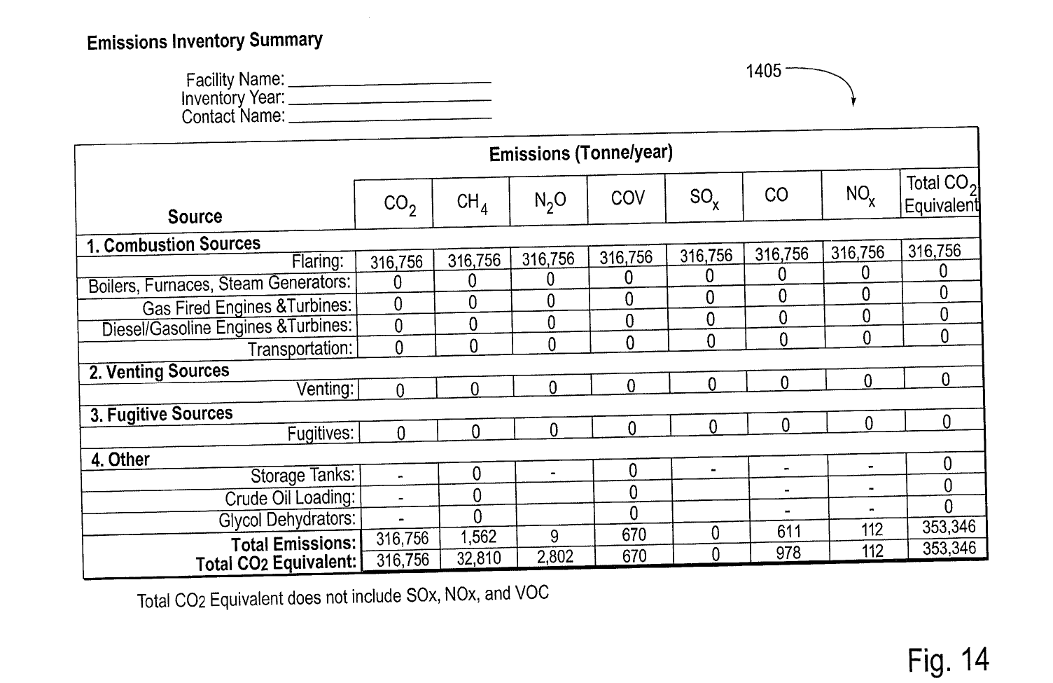

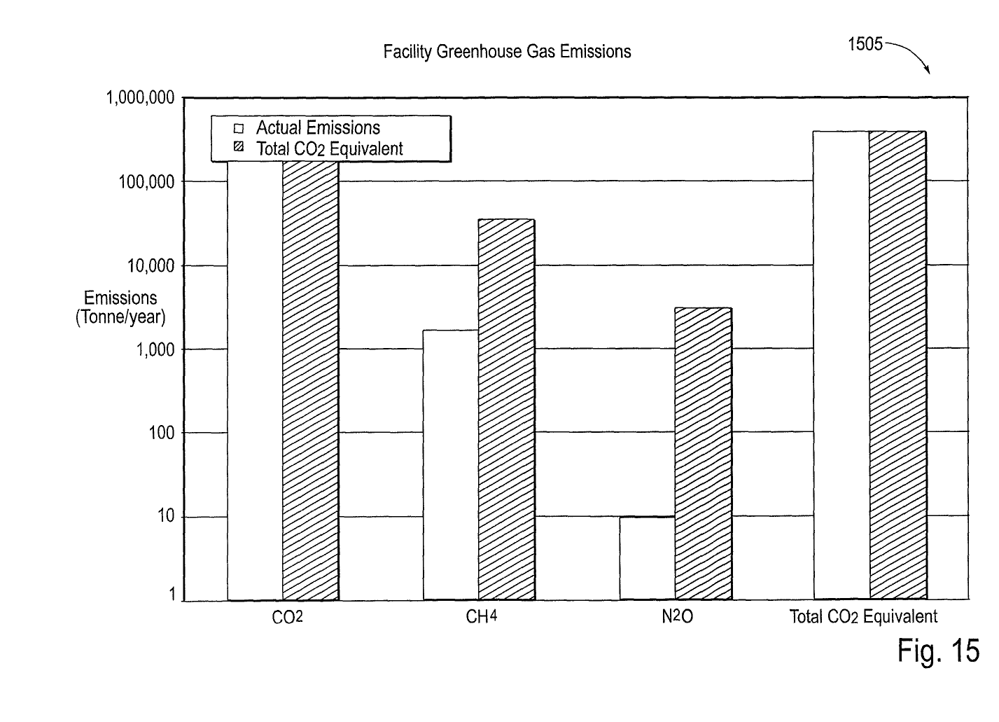

FIGS. 14 and 15 depict in one embodiment of the invention, exemplary reports from a relational database used in the invention in storing an integrated GHG inventory.

The same or similar data collected from each facility is optionally collected and used to track energy usage as well as GHG emissions. All the data collection, integration, and reporting concepts of the system applicable to GHG tracking also apply to energy usage tracking.

Since the various messages transferred between processes and entities in the method of the invention may contain sensitive information users and system administrators may want to ensure the security of such information. Security may be a concern because information transmitted over the Internet may pass through various intermediate computer systems on its way to its final destination. The information could be intercepted by an unscrupulous person at an intermediate system.

To help ensure the security of the sensitive information, various encryption techniques are optionally used when transmitting such information between computer systems. Virtual Private Networks also provide secure messaging via encryption. Even though such encrypted information can be intercepted, because the information is encrypted, it is generally useless to the interceptor.

D. Other Implementation Details

1. Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

7. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A method for energy and green-house gas inventory management comprising:
(a) entering input data and input source descriptions for the input from green-house-gas-producing processes at a field site into a computer-readable file;
(b) passing the input data to a green-house-gas calculating module;
(c) outputting green-house-gas emissions based on the input data;
(d) passing the input, input source descriptions, and the output over a network to an output integration program;
(e) integrating the output with a plurality of other output from a plurality of other field sites;
(f) mapping the integrated output into a relational database schema; and
(g) storing the mapped integrated output in a relational database.

2. The method of claim 1, further comprising querying the relational database and returning the results of the query.

3. The method of claim 1, wherein the calculating module further calculates energy consumption based on the input data.

4. The method of claim 1, wherein the input, source data for the input, and the output are passed over the network as a single flat file.

5. The method of claim 1, wherein the input data is passed over a network to the calculating module located on a remote computer.

6. The method of claim 1, wherein the network comprises the Internet.

7. The method of claim 1, further comprising an intermediate integration step for processing input data from a plurality of field sites in a common geographic region.

8. The method of claim 1, further comprising passing the data to an energy usage calculating module; outputting energy usage based on the input data; and passing the energy usage over the network to the output integration program.

9. A data processing apparatus for maintaining an inventory of green-house gas emissions, comprising:
(a) a CPU; and
(b) a memory operatively connected to the CPU, the memory containing a program adapted to be executed by the CPU and the CPU and memory cooperatively adapted to:
(1) displaying a form for inputting data and input source descriptions for the input from green-house-gas-producing processes at a field site into a computer-readable file;
(2) passing the input data to a green-house-gas calculating module;
(3) calculating green-house-gas emissions based on the input data;
(4) passing the input, input source descriptions, and the output over a network to an output integration program;
(5) integrating the output with a plurality of other output from a plurality of other field sites;
(6) mapping the integrated output into a relational database schema; and
(7) storing the mapped integrated output in a relational database.

10. The data processing apparatus of claim 9, wherein the CPU and memory are further cooperatively adapted to query the relational database and return the results of the query.

11. The data processing apparatus of claim 9, wherein the CPU and memory are further cooperatively adapted to calculate energy consumption based on the input data.

12. The data processing apparatus of claim 9, wherein the CPU and memory are further cooperatively adapted to pass the input, source data for the input, and the output over the network as a single flat file.

13. The data processing apparatus of claim 9, wherein the CPU and memory are further cooperatively adapted pass the input data over a network to the calculating module, wherein the calculating module is contained in a memory of a remote computer.

14. The data processing apparatus of claim 9, wherein the network comprises the Internet.

15. The data processing apparatus of claim 9, wherein the CPU and memory are further cooperatively adapted to further perform an intermediate integration step for processing input data from a plurality of field sites in a common geographic region.

16. The data processing apparatus of claim 9, further comprising means for remotely updating the means for calculating green-house-gas at each of the field sites.

17. The data processing apparatus of claim 9, wherein the relational database is accessible from a remote node over a network.

18. The data processing apparatus of claim 9, further comprising the memory cooperatively adapted to passing the data to an energy usage calculating module; outputting energy usage based on the input data; and passing the energy usage over the network to the output integration program.

19. A computer program embodied on at least one computer-readable medium, the computer program for maintaining an inventory of energy usage and green-house gas emissions, comprising:
(a) a code segment configured and adapted for displaying a form for inputting data and input source descriptions for the input from green-house-gas-producing processes at a field site into a computer-readable file;
(b) a code segment configured and adapted for passing the input data to a green-house-gas calculating module;
(c) a code segment configured and adapted for calculating green-house-gas emissions based on the input data;
(d) a code segment configured and adapted for passing the input, input source descriptions, and the output over a network to an output integration program;
(e) a code segment configured and adapted for integrating the output with a plurality of other output from a plurality of other field sites;
(f) a code segment configured and adapted for mapping the integrated output into a relational database schema; and
(g) a code segment configured and adapted for storing the mapped integrated output in a relational database.

20. The computer program of claim 19, further comprising a code segment configured and adapted for querying the relational database and returning the results of the query.

21. The computer program of claim 19, wherein the calculating module further comprises a code segment configured and adapted for calculating energy consumption based on the input data.

22. The computer program of claim 19, further comprising a code segment configured and adapted for passing the input data, source data for the input data, and the output the network as a single flat file.

23. The computer program of claim 19, further comprising a code segment configured and adapted for passing the input data over a network to the calculating module located on a remote computer.

24. The computer program of claim 19, wherein the network comprises the Internet.

25. The computer program of claim 19, further comprising a code segment configured and adapted for an intermediate integration step of processing input data from a plurality of field sites in a common geographic region.

26. The computer program of claim 19, further comprising a code segment configured and adapted for passing the data to an energy usage calculating module; outputting energy usage based on the input data; and passing the energy usage over the network to the output integration program.
